(19) United States
(12) Patent Application Publication
(10) Pub. No.: US 2026/0103925 A1
(43) Pub. Date: Apr. 16, 2026

(54) SELF-ADJUSTING LATERAL MOVEMENT ANCHOR FOR MULTI-ACCESS TAILGATE

(71) Applicant: Ford Global Technologies, LLC, Dearborn, MI (US)

(72) Inventors: Joseph Prior, Detroit, MI (US); Joshua Robert Hemphill, White Lake, MI (US); Michael Shawn Watterworth, Brighton, MI (US)

(21) Appl. No.: 18/911,911

(22) Filed: Oct. 10, 2024

(51) Int. Cl. E05C 19/00; B62D 33/027

(52) U.S. Cl. CPC E05C 19/00; B62D 33/0273

(57) ABSTRACT

An apparatus and method for installing a lateral movement anchor assembly includes fixing a base to a vehicle box structure, installing an adjustment block on the base, and fixing an anchor to a tailgate. The tailgate is then closed such that the anchor interacts with the adjustment block and moves the adjustment block to a final assembly position. Once in the final assembly position, the adjustment block and the base structure are fixed to the vehicle box structure.

### TECHNICAL FIELD

This disclosure relates generally to a tailgate with lateral movement anchors on each side to reduce noise and vibration during closing movement.

### BACKGROUND

Vehicles may include a tailgate that is moveable between a closed position and an open position to allow access to a cargo area. Noise and vibration issues may occur during closing operations.

### SUMMARY

An assembly according to an exemplary aspect of the present disclosure includes, among other things: a base including a box attachment interface; an adjustment block moveably coupled to the base; a post including a tailgate attachment interface, wherein the post moves the adjustment block to a final assembly position; and a securement device that fixes the adjustment block to the base in the final assembly position.

In a further non-limiting embodiment of any assembly, the post comprises a first end that is fixed to a tailgate and a second end that comprises an anchor that is received within the adjustment block.

In a further non-limiting embodiment of any assembly, the base comprises a locating member to locate the base relative to a vehicle box structure.

In a further non-limiting embodiment of any assembly, the base attachment interface comprises a fastening element that holds the base fixed relative to a vehicle box structure.

In a further non-limiting embodiment of any assembly, one end of the adjustment block includes a slot with a flared opening that receives an anchor formed on one end of the post.

In a further non-limiting embodiment of any assembly, the slot opens into a recessed area that receives the securement device.

In a further non-limiting embodiment of any assembly, the securement device comprises at least one fastener.

An assembly according to an exemplary aspect of the present disclosure includes, among other things: a vehicle box structure; a tailgate moveable relative to the vehicle box structure between an open position and a closed position; and at least one anchor assembly to control lateral movement between the tailgate and vehicle box structure, wherein the at least one anchor assembly comprises: a base attached to the vehicle box structure; an adjustment block moveably coupled to the base; a post attached to the tailgate, wherein the post moves the adjustment block to a final assembly position; and a securement device that fixes the adjustment block to the base in the final assembly position.

In a further non-limiting embodiment of any apparatus, the post comprises a cylindrical body with a first end fixed to the tailgate and extending to a second end that comprises an anchor that is received within the adjustment block.

In a further non-limiting embodiment of any apparatus, the base includes at least one slot that receives at least one guide member on the adjustment block such that the adjustment block can slide relative to the base.

In a further non-limiting embodiment of any apparatus, one end of the adjustment block includes a slot with a flared opening that receives the anchor.

In a further non-limiting embodiment of any apparatus, the slot opens into a recessed area that receives the securement device.

In a further non-limiting embodiment of any apparatus, the securement device comprises at least one fastener having a head portion that fits within the recessed area and a distal end portion that extends through an adjustment slot in the adjustment block, through an aperture in the base and into the vehicle box structure.

In a further non-limiting embodiment of any apparatus, the base includes a locating member to locate the base relative the a vehicle box structure and at least one a fastening element that holds the base fixed relative to the vehicle box structure prior to installation of the securement device.

In a further non-limiting embodiment of any apparatus, the tailgate comprises a multi-access tailgate that includes a center door positioned between a right side panel and a left side panel, and wherein the at least one anchor assembly comprises a first anchor assembly associated with the right side panel and a second anchor assembly associated with the left side panel.

A method according to an exemplary aspect of the present disclosure includes, among other things: fixing a base to a vehicle box structure; installing an adjustment block on the base; fixing an anchor to a tailgate; closing the tailgate such that the anchor interacts with the adjustment block and moves the adjustment block to a final assembly position; and subsequently fixing the adjustment block to the base structure and vehicle box structure.

In a further non-limiting embodiment of any method, after the adjustment block is in the final assembly position, the method includes opening the tailgate and fixing the adjustment block to the base structure with at least one fastener.

In a further non-limiting embodiment of any method, the method includes sliding one or more guide members on the adjustment block into a sliding guide track formed on the base prior to closing the tailgate.

In a further non-limiting embodiment of any method, the method includes guiding the anchor into a slot formed in the adjustment block via a flared opening.

In a further non-limiting embodiment of any method, contact of the anchor against the adjustment block at the flared opening moves the adjustment block toward the final assembly position.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a perspective view of a multi-access tailgate in a tailgate open position.

FIG. 2 is similar to FIG. 1 but shows a tailgate closed position with a swing door in an open position.

FIG. 3 is similar to FIG. 1 but shows a tailgate closed position and a swing door in a closed position.

FIG. 4A is a front perspective view of a lateral movement anchor assembly comprising a post, a base, an adjustment block, and a securement device.

FIG. 4B is similar to FIG. 4A but has the post removed.

FIG. 5 is a z-section view of the lateral movement anchor assembly installed in a vehicle with a tailgate in a closed position.

FIG. 6 is similar to FIG. 5 but shows an x-section view.

FIG. 7 is a perspective view of the post of FIG. 4A.

FIG. 8A is a front perspective view of the base of FIG. 4A.

FIG. 8B is a rear perspective view of the base of FIG. 4A.

FIG. 9A is a perspective end view of the adjustment block of FIG. 4A.

FIG. 9B is an end view of the adjustment block of FIG. 9A.

FIG. 9C is a front view of the adjustment block of FIG. 9A.

FIG. 10 is a perspective view of the lateral movement anchor assembly of FIG. 4B as installed in a vehicle.

FIG. 11A is a side view of the adjustment block and base in a nominal position.

FIG. 11B is similar to FIG. 11A but shows a shipping/initial installed position.

FIG. 12 is an end section view showing the tailgate in a 5 degree open position as the post begins to enter the adjustment block.

FIG. 13 is similar to FIG. 12 but shows the tailgate in a closed position with the adjustment block moved to an installation position.

FIG. 14 is a perspective view with the tailgate open and the adjustment block in the installation position, and with the securement device installed to fix the adjustment block in the installation position.

FIG. 15A is similar to FIG. 12 but shows the tailgate in a 4 degree open position at minimum margin.

FIG. 15B is similar to FIG. 15A but shows the tailgate closed at minimum margin.

FIG. 16A is similar to FIG. 15A but shows the tailgate in a 5 degree open position at maximum margin.

FIG. 16B is similar to FIG. 16A but shows the tailgate closed at maximum margin.

### DETAILED DESCRIPTION

This disclosure details a tailgate with lateral movement anchors on each side of the tailgate to reduce noise and vibration during closing movement.

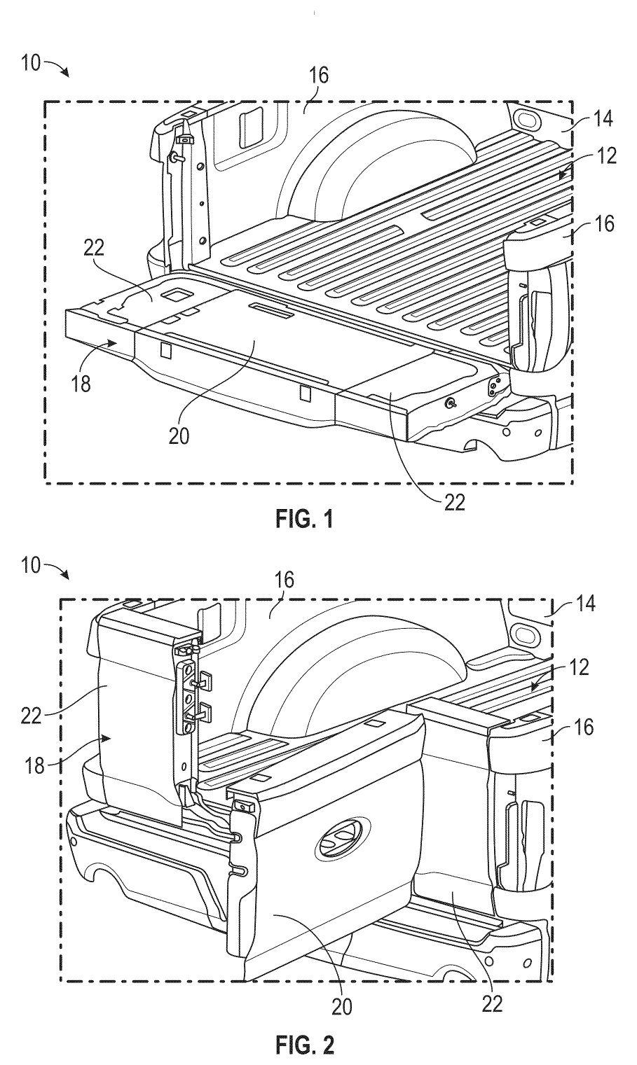

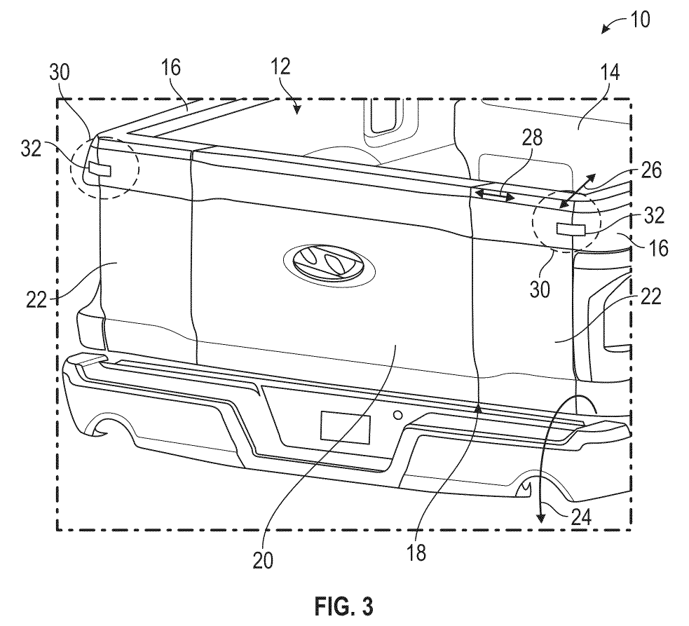

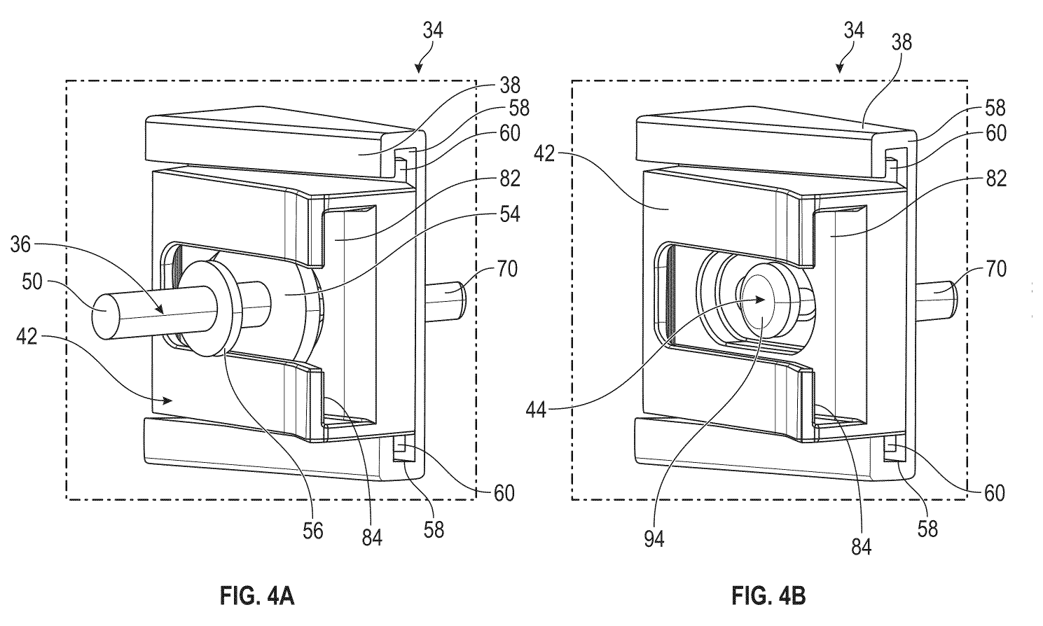

FIG. 1 shows a vehicle 10 that includes a cargo area 12 that is enclosed by a front wall 14, side walls 16, and a tailgate 18 at one end of the cargo area 12. In implementations, the tailgate 18 may comprise a multi-access tailgate (MAT) that includes a center door 20 that is positioned between right and left side panels 22, e.g., side doors. The side panels 22 and center door 20 move as a unit between a traditional tailgate open position (FIG. 1) and a closed position (FIG. 3). In implementations, when in the closed position, the center door 20 can swing to an open position independent of the side panels 22 to allow access to the cargo area 12 as shown in FIG. 2.

In implementations, both side panels 22, e.g., outboard tailgates, are allowed to rotate at tailgate hinges around a Y (cross-car) axis as shown by arrow 24 in FIG. 3. In one example, both side panels 22 are constrained in a fore/ aft (open/closed) direction at a tailgate closure area 30 as shown by arrow 26 in FIG. 3. Traditionally, the side panels 22 are not constrained in the Y (cross-car direction) at the tailgate closure area 30 as shown by arrow 28 in FIG. 3.

In implementations, the tailgate 18 includes closure assemblies, schematically shown at 32 in FIG. 3, which are used to secure each end of the tailgate to a box structure, e.g. frame member, in the closed position. Any type of closure mechanism can be installed for this purpose. In one example, a closure assembly may comprise a closure associated with one of the tailgate and a box structure and a striker associated with the other of the tailgate and box structure; however, other types of closure assemblies may also be used.

In implementations, the lack of constraint in Y at or near the tailgate closure area 30, may allow for three possible issues. First, there may be deflection of a fully trimmed tailgate due to gravity. In one example, the installation of the tailgate may be preset to compensate for the deflection. Preset is the act of setting a part away from a nominal position anticipating deflection from the part’s own weight and later assembled parts. The deflection brings everything to nominal. The dimensional preset ensures that fit and finish as well as functional requirements, e.g., closure/striker alignment and seal gaps, are met on a completed vehicle.

In implementations of a MAT, the side panels 22 attach and apply load to the vehicle body, specifically, a rigid and fixed hinge pillar, where the hinge pillar on the MAT is a non-rigid, non-fixed, rotating tailgate, e.g., side panel 22. Without a Y, cross-car, constraint, the “hinge pillar” is allowed to rotate in a rear view, and as a mass of the center swing door increases, drop off deflection may increase. As drop off deflection increases, preset must increase which may lead to increased variation in fit/finish and closure/striker alignment.

Second, there may be sag deflection when an open swing center door 20 is loaded vertically. For example, someone may place items on top of the center swing door when the door is an open position. Without a Y, cross-car, constraint, the right hand side panel and center swing door may deflect, e.g., sag, from the additional applied load.

Finally, as the center swing door 20 is closed, there may be door input energy which may cause the entire tailgate 18 to move back and forth laterally. For example, when closing the center swing door, closing energy may cause the entire tailgate assembly to move back and forth laterally, gradually reducing in amplitude like a damped sin wave. This movement may cause unwanted vibrations and/or a rattling noise in the closure assemblies.

To address these issues, the subject disclosure provides for a lateral movement anchor assembly 34, on each of the right and left sides of the tailgate 18, to prevent tailgate closure assemblies 32 from sliding along the strikers and vibrating laterally when closing the center swing door 20. In implementations, the lateral anchor system may be uniquely set to each truck, e.g., the anchor assemblies are self-adjusting. Additionally, the lateral anchor system is robust to build variation, e.g., cross-car margin and fore/aft flushness, and is easily to assemble and manage.

In implementations, the lateral movement anchor assemblies 34 comprise at least: an anchor 36, e.g., a post, which is attached to the tailgate 18; a base 38 that is attached to a vehicle box structure 40 (FIG. 5), e.g. a frame member; an adjustment block 42 that adjusts along an angle to accommodate margin variation; and a securement device 44, e.g. a fastener, which secures the adjustment block 42 and base 38 to the box structure 40. In implementations, the anchor assemblies 34 control lateral movement between the tailgate 18 and vehicle box structure 40.

In implementations, the adjustment block 42 is moveably coupled to the base 38, and the post 36 moves the adjustment block 42 to a final assembly position during a first closing event of the tailgate 18. Once the adjustment block 42 is in the final assembly position, the tailgate 18 is opened and the securement device 44 fixes the adjustment block 42 to the base 38 and the box 40 in the final assembly position.

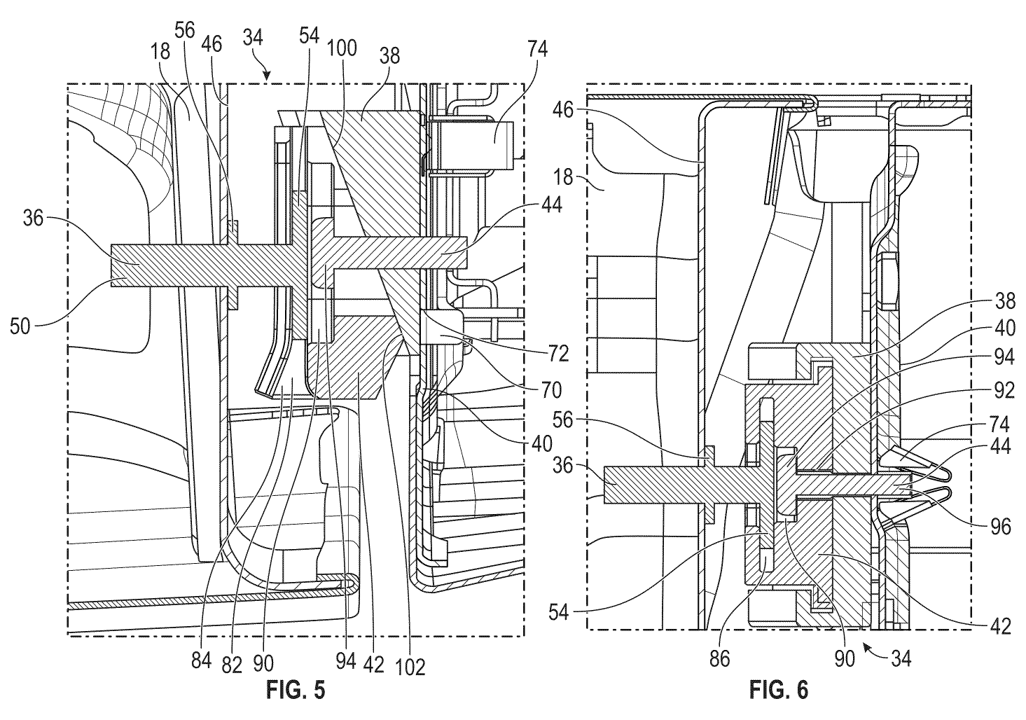

In one example, the post 36 is fixed to an outwardly facing edge surface 46 of the tailgate 18 as shown in FIGS. 5-6. In one example, the adjustment block 42 is fixed in place through the base 38 and into the box structure 40 via the securement device 44. In implementations, once in the final assembly position, the post 36 swings inside the adjustment block 42 as the tailgate 18 moves to the closed position. The post 36 then becomes trapped inside the adjustment block 42 as shown in FIG. 6, which prevents the tailgate 18 from moving laterally.

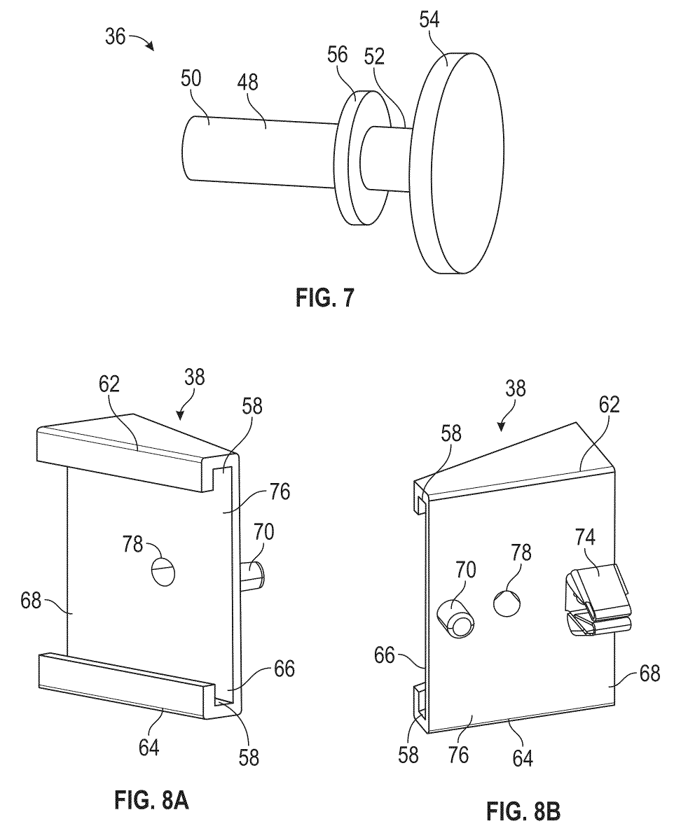

In implementations, the post 36 comprises a cylindrical body 48 (FIG. 7) with a first end 50 fixed to the tailgate 18 (FIG. 5) and extending to a second end 52 that includes an anchor 54 that is received within the adjustment block 42. In one example, the anchor 54 comprises a disc shaped portion as shown in FIG. 7. In implementations, the post 36 also includes another disc-shaped portion 56 that provides a touch off surface when the post 36 is torqued to the tailgate 18. In one example, the disc-shaped portion 56 comprises a washer feature. In one example, the disc-shaped portion 56 is smaller in diameter than the anchor 54.

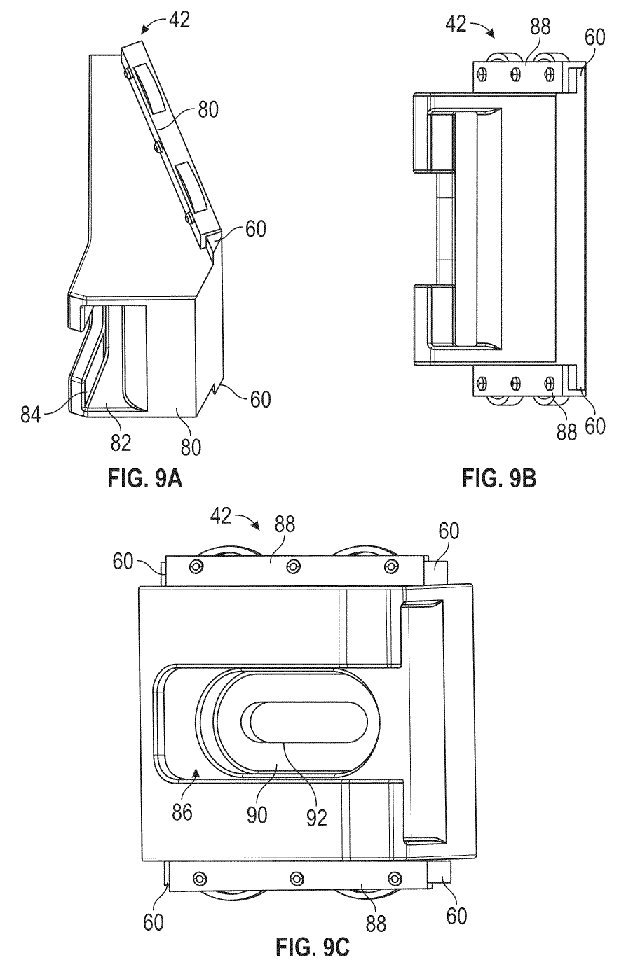

In implementations, the base 38 comprises a block-like structure that includes one or more slots 58 (FIGS. 8A-8B) that receive at least one guide member 60 (FIGS. 9A-9C) on the adjustment block 42 such that the adjustment block 42 can slide relative to the base 38. In one example, the base 38 includes slots 58 at upper 62 and lower 64 edges, and the slots 58 extend from an aft edge 66 to a fore edge 68. In implementations, the slots 58 comprise guide channels that guide adjustment block 42 along the block at an angle.

In implementations, the base 38 includes a locating member 70 to locate the base 38 relative to the vehicle box structure 40 during an initial installation. In one example, the locating member 70 comprises a pin inserted through an opening 72 (FIG. 5) in the box structure 40.

In implementations, the base 38 includes a fastening element 74 that holds the base 38 fixed relative to the vehicle box structure 40 during the adjustment process. In one example, the fastening element 74 comprises a spring-loaded clip as shown in FIG. 8B.

In implementations, the base 38 comprises a flat plate portion 76 that extends between the slots 58, and which includes a through hole 78 that receives the securement device 44 once the adjustment block 42 is in the final assembly position.

In implementations shown in FIGS. 9A-9C, one end 80 of the adjustment block 42 includes a slot 82 with a flared opening 84 that receives the anchor 54. The flared opening 84 accepts and guides the anchor 54 into an anchor cavity 86 as shown in FIG. 9C.

In one example, the adjustment block 42 includes a plurality of guide members 60, e.g. guide tabs, at opposing upper and lower edges to direct the adjustment block 42 into the slots 58 of the base 38.

In implementations, there may be rubber overmolds 88 on top of the guide tabs 60 that are designed with an interference fit to the base 38 to prevent unintended movement of the adjustment block, both during shipping/assembly and when opening the tailgate 18 prior to securing the adjustment block 42 with the securement member 44 when in the final assembly position.

In implementations, the slot 82 in the base 38 opens into a recessed area 90 that receives the securement member 44 as shown in FIG. 9C. In implementations, the recessed area 90 includes a slot 92 that aligns with the through hole 78 in the base 38 such that the securement member 44 can be inserted through the slot 92 and the hole 78 in any of the adjustment positions that may provide the final assembly position. In one example, the recessed area 90 allows the securement member 44 to hold the attached components in a fixed position without interfering with the anchor 54 during subsequent opening and closing of the tailgate 18.

In implementations, the securement device 44 comprises at least one fastener having a head portion 94 (FIG. 6) that fits within the recessed area 90 and a distal end portion 96 that extends through the adjustment slot 92 in the adjustment block 42, through the hole 78 in the base 38, and into the vehicle box structure 40.

In implementations, the lateral movement anchor assemblies 34 are installed as described below. In one example, the base 38 and adjustment block 42 are assembled together as a unit as shown in FIG. 11A. The adjustment block 42 may be moved to a shipping/initial installed position as shown in FIG. 11B. In the shipping/initial installed position, the adjustment block 42 is translated aft and outboard as shown in FIG. 11B to accept a tailgate shifted outboard with less than minimum margin of tailgate to box structure 40.

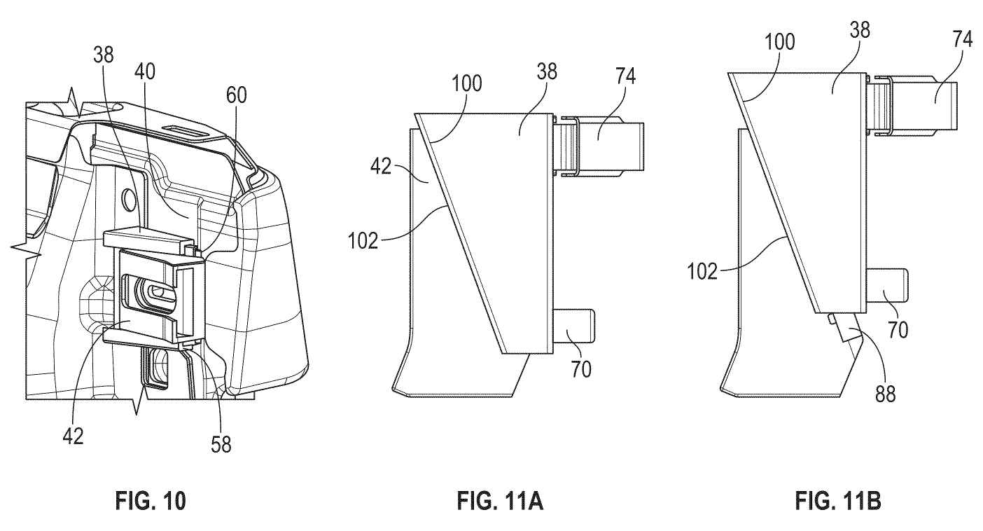

In one example, the unit of the adjustment block 42 and base 38 is then located to the box structure 40 with the pin 70, and clipped to the box structure 40 with the fastening element 74 as shown in FIG. 10. The post 36 is secured to an end of an open tailgate 18.

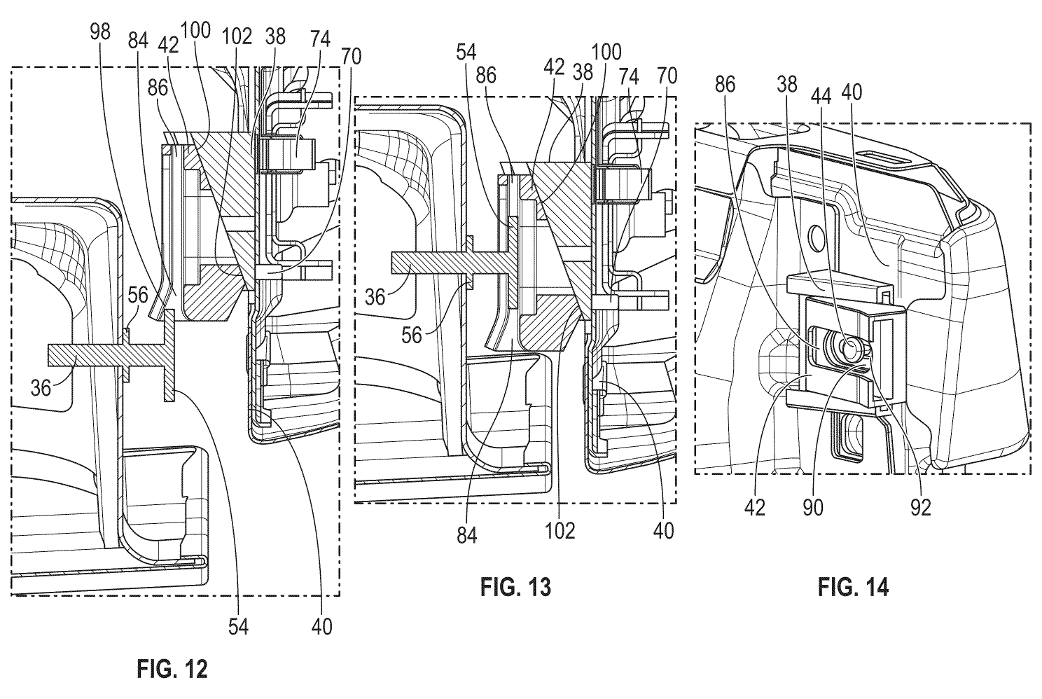

In one example, the alignment and securement process is as described below. An operator closes the tailgate 18 such that the post 36 contacts a ramped surface 98 of the adjustment block 42 at the flared opening 84 (see FIG. 12 with tailgate being in a 5 degree open position). The post 36 pushes the adjustment block 42 forward and inboard along a guide channel angled surface 100 that interacts with an angled block surface 102 until the adjustment block 42 adjusts to tailgate to box margin. In one example, "margin" refers to an allowable deviation from a specified dimension or specification within which a component or assembly can still be considered acceptable. Once in this final adjustment/assembly position as shown in FIG. 13, the operator opens the tailgate 18 and inserts the securement member 44 through the aligned slot 92 and hole 78, and into the box structure 40 as shown in FIG. 14.

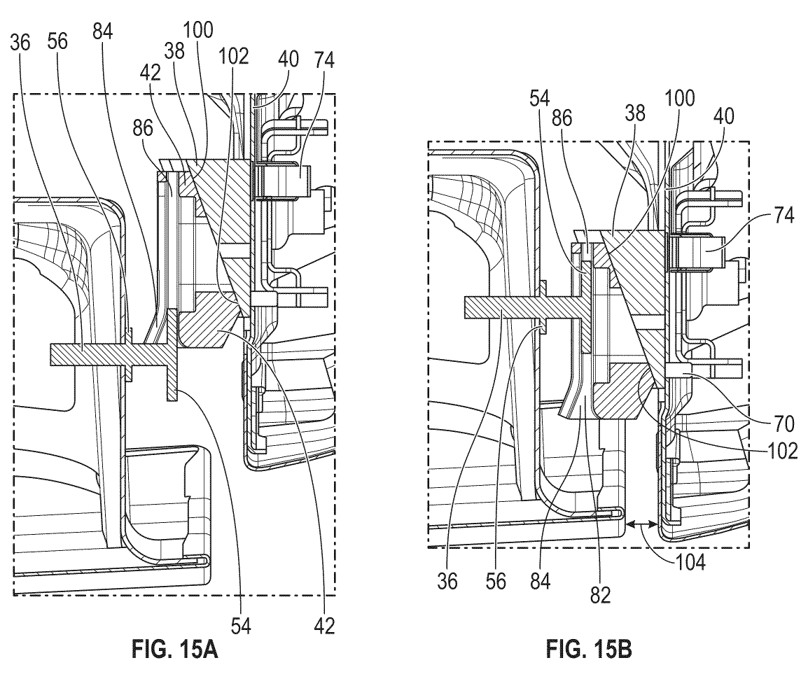

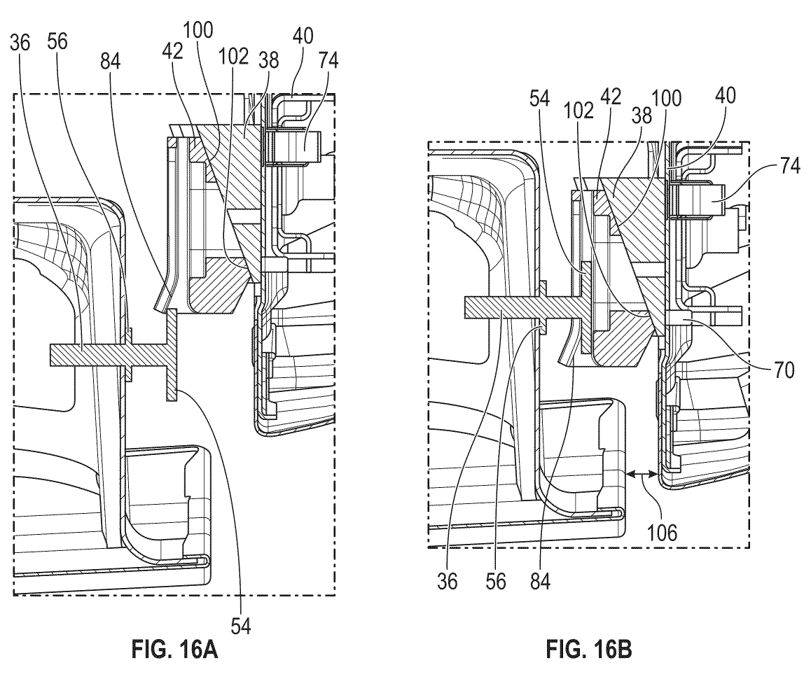

The subject disclosure provides for a robust to margin variation for the tailgate to box structure. FIGS. 15A-15B show an example for a minimum margin and FIGS. 16A-16B show an example for a maximum margin.

In one example, at a minimum margin 104, the post 36 contacts the adjustment block 42 (FIG. 15A) and pushes the adjustment block 42 a small amount before the post 36 enters the anchor cavity 86 (FIG. 15B).

In one example, at a maximum margin 106, the post 36 contacts the adjustment block 42 (FIG. 16A) and pushes the adjustment block 42 a significant amount before the post 36 enters the anchor cavity 86 (FIG. 16B).

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly, comprising:
a base including a box attachment interface;
an adjustment block moveably coupled to the base;
a post including a tailgate attachment interface, wherein the post moves the adjustment block to a final assembly position; and
a securement device that fixes the adjustment block to the base in the final assembly position.

2. The assembly of claim 1, wherein the post comprises a first end that is fixed to a tailgate and a second end that comprises an anchor that is received within the adjustment block.

3. The assembly of claim 1, wherein the base comprises a locating member to locate the base relative to a vehicle box structure.

4. The assembly of claim 1, wherein the box attachment interface comprises a fastening element that holds the base fixed relative to a vehicle box structure.

5. The assembly of claim 1, wherein one end of the adjustment block includes a slot with a flared opening that receives an anchor formed on one end of the post.

6. The assembly of claim 5, wherein the slot opens into a recessed area that receives the securement device.

7. The assembly of claim 1, wherein the securement device comprises at least one fastener.

8. An apparatus comprising:
a vehicle box structure;
a tailgate moveable relative to the vehicle box structure between an open position and a closed position; and
at least one anchor assembly to control lateral movement between the tailgate and the vehicle box structure, wherein the at least one anchor assembly comprises:
a base attached to the vehicle box structure;
an adjustment block moveably coupled to the base;
a post attached to the tailgate, wherein the post moves the adjustment block to a final assembly position; and
a securement device that fixes the adjustment block to the base in the final assembly position.

9. The apparatus of claim 8, wherein the post comprises a cylindrical body with a first end fixed to the tailgate and extending to a second end that comprises an anchor that is received within the adjustment block.

10. The apparatus of claim 9, wherein the base includes at least one slot that receives at least one guide member on the adjustment block such that the adjustment block can slide relative to the base.

11. The apparatus of claim 9, wherein one end of the adjustment block includes a slot with a flared opening that receives the anchor.

12. The apparatus of claim 11, wherein the slot opens into a recessed area that receives the securement device.

13. The apparatus of claim 12, wherein the securement device comprises at least one fastener having a head portion that fits within the recessed area and a distal end portion that extends through an adjustment slot in the adjustment block, through an aperture in the base ,and into the vehicle box structure.

14. The apparatus of claim 8, wherein the base includes a locating member to locate the base relative to the vehicle box structure and at least one a fastening element that holds the base fixed relative to the vehicle box structure prior to installation of the securement device.

15. The apparatus of claim 8, wherein the tailgate comprises a multi-access tailgate that includes a center door positioned between a right side panel and a left side panel, and wherein the at least one anchor assembly comprises a first anchor assembly associated with the right side panel and a second anchor assembly associated with the left side panel.

16. A method comprising:
fixing a base to a vehicle box structure;
installing an adjustment block on the base;
fixing an anchor to a tailgate;
closing the tailgate such that the anchor interacts with the adjustment block and moves the adjustment block to a final assembly position; and
subsequently fixing the adjustment block to the base and the vehicle box structure.

17. The method of claim 16, wherein after the adjustment block is in the final assembly position, opening the tailgate and fixing the adjustment block to the base with at least one fastener.

18. The method of claim 16, including sliding one or more guide members on the adjustment block into a sliding guide track formed on the base prior to closing the tailgate.

19. The method of claim 18, including guiding the anchor into a slot formed in the adjustment block via a flared opening.

20. The method of claim 19, wherein contact of the anchor against the adjustment block at the flared opening moves the adjustment block toward the final assembly position.
